(19) United States
(12) Patent Application Publication
(10) Pub. No.: US 2022/0161820 A1
(43) Pub. Date: May 26, 2022

(54) AUTONOMOUS VEHICLE ROUTE DEPLOYMENT SYSTEMS AND METHODS

(71) Applicant: Sensible 4 Oy, Espoo (FI)

(72) Inventors: Gábor Major, Espoo (FI); Umar Zakir Abdul Hamid, Espoo (FI); Jari Saarinen, Espoo (FI); Aku Kyyhkynen, Espoo (FI)

(73) Assignee: Sensible 4 Oy, Espoo (FI)

(21) Appl. No.: 17/534,303

(22) Filed: Nov. 23, 2021

Related U.S. Application Data
(60) Provisional application No. 63/118,481, filed on Nov. 25, 2020.

(51) Int. Cl. B60W 60/00; B60W 40/10; B60W 40/12

(52) U.S. Cl. CPC B60W 60/0013; B60W 40/10; B60W 2720/24; B60W 2556/45; B60W 40/12

(57) ABSTRACT

Embodiments of the disclosed systems and methods provide systems and techniques for improving reference route and/or trajectory information for autonomous vehicles that may allow for better operation and/or deployment. In certain embodiments, various optimization techniques may be employed for generating higher quality reference route and/or trajectory information based on initial reference route and/or trajectory information captured by an autonomous vehicle. Various embodiments of the disclosed systems and methods may improve reference route and/or trajectory information through processes that may involve editing and/or otherwise modifying initial route and/or trajectory information, smoothing path curves associated with initial reference route and/or trajectory information, modifying initial route and/or trajectory information based on vehicle-specific dynamics and/or parameters, and/or modifying velocities for improved passenger comfort.

### RELATED APPLICATIONS

This application claims benefit of priority under 35 U.S.C. § 119(e) to U.S. Provisional Patent Application No. 63/118,481, filed Nov. 25, 2020, and entitled “AUTONOMOUS VEHICLE ROUTE DEPLOYMENT SYSTEMS AND METHODS,” which is incorporated herein by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to systems and methods for autonomous vehicle route deployment. More specifically, but not exclusively, the present disclosure relates to systems and methods for generating and deploying accurate reference route and/or trajectory information to an autonomous vehicle that allows for improved autonomous operation.

Autonomous vehicles (“AVs”) may be deployed in an operational area that includes one or more defined vehicle routes and/or paths. An operational area may comprise, for example and without limitation, a region, a city, a portion of a city, and/or any other geographical area where AVs may operate. AVs may transit an operational area along one or more defined routes and/or paths that, in some circumstances, may include one or more defined vehicle stops and/or stations.

To facilitate autonomous operation within an operational area, routes and/or associated vehicle trajectories for an AV may be defined by initially driving the routes in a vehicle with a human driver and/or under human-assisted driving control. Reference route and/or associated trajectory information may be recorded by the vehicle, and this recorded data may be later used to define routes and/or associated vehicle trajectories along the routes during autonomous operation. For example, reference route and/or associated trajectory information may be used to provide routes and/or trajectories that an AV can later follow during operation and that AV fleet management services may use in connection with vehicle routing.

Effective autonomous operation of an AV may depend, at least in part, on the accuracy and/or quality of reference route and/or associated trajectory information used in connection with autonomous control decisions. Initial reference route and/or trajectory information recorded by an AV, however, may be affected by noise and/or other inaccuracies that may impact autonomous control decisions based on such reference route and/or trajectory information. For example, initial reference route and/or trajectory information recorded by an AV may be impacted by, for example and without limitation, sensor and/or other vehicle positioning system noise, actions of a human driver (e.g., slide miss maneuvers, object and/or roadway damage evasion maneuvers, brake applications, etc.), and/or the like.

Embodiments of the disclosed systems and methods may be used to improve and/or optimize initial reference route and/or trajectory information to provide higher quality and/or otherwise improved reference route and/or trajectory information. As described in more detail below, various embodiments of the disclosed systems and methods may improve reference route and/or trajectory information by, for example and without limitation, editing and/or otherwise modifying route and/or trajectory information (e.g., adding stops along the route, changing path and/or routing information, etc.), smoothing path curves associated with reference route and/or trajectory information, modifying route and/or trajectory information based on vehicle-specific dynamics and/or parameters, and/or modifying velocities for improved passenger comfort, and/or the like.

### BRIEF DESCRIPTION OF THE DRAWINGS

The inventive body of work will be readily understood by referring to the following detailed description in conjunction with the accompanying drawings, in which:

FIG. 1 illustrates an example of a high-level architecture for generating initial reference route and/or trajectory information and improved reference route and/or trajectory information consistent with certain embodiments of the present disclosure.

FIG. 2 illustrates a conceptual diagram showing a process of generating improved reference route and/or trajectory information consistent with certain embodiments of the present disclosure.

FIG. 3 illustrates a conceptual diagram showing a process of generating improved reference route and/or trajectory information including offline planning and/or path modification services consistent with certain embodiments of the present disclosure.

FIG. 4 illustrates a flow chart of an example of a method of generating improved reference route and/or trajectory information consistent with certain embodiments of the present disclosure.

FIG. 5 illustrates a flow chart of an example of a method of improving reference route and/or trajectory information using trajectory smoothing techniques based on vehicle parameters consistent with certain embodiments of the present disclosure.

FIG. 6 illustrates a flow chart of an example of a method of improving reference route and/or trajectory information using velocity planning techniques consistent with certain embodiments of the present disclosure.

FIG. 7 illustrates an example of a system that may be used to implement certain embodiments of the systems and methods of the present disclosure.

### DETAILED DESCRIPTION

A description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may in some instances be designated by like numbers and/or descriptions. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods provide techniques for improving reference route and/or trajectory information that may, among other things, allow for better operation and/or deployment of AVs. Although various embodiments and examples are generally described herein as being used in connection with AVs, it will be appreciated that the described embodiments of the disclosed systems and methods not may be used in connection with fully-autonomous, semi-autonomous, and/or other assisted driving vehicles (e.g., assisted driving vehicles driven at least in part by an in-vehicle driver and/or a remote operator). Moreover, it will be appreciated that various aspects of the disclosed embodiments may be used in connection with a variety of types of vehicles including, for example and without limitation, passenger vehicles, transit vehicles, freight vehicles, land-based vehicles, watercraft, aircraft, and/or the like.

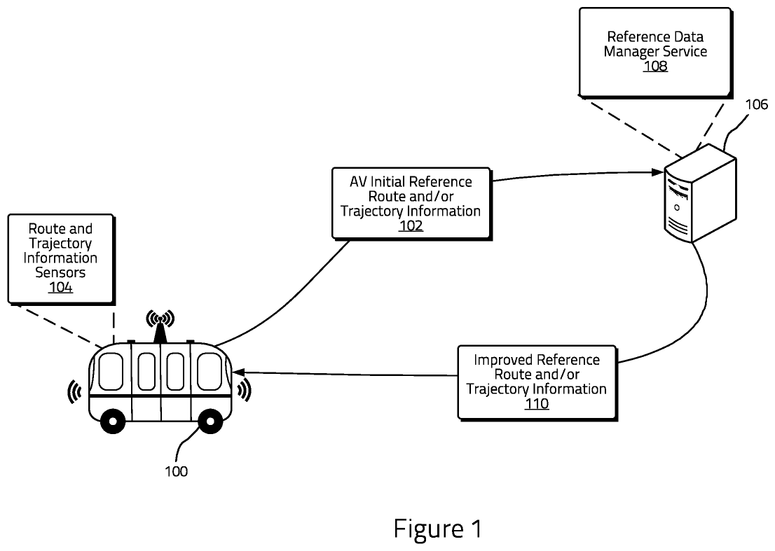

FIG. 1 illustrates an example of a high-level architecture for generating initial reference route and/or trajectory information and improved reference route and/or trajectory information consistent with certain embodiments of the present disclosure. As illustrated, an AV 100 may generate and/or otherwise record initial route and/or trajectory information 102. In various embodiments, the initial route and/or trajectory information 102 may comprise a variety of vehicle position and/or location data (e.g., x-y-z position data, velocity data such as linear x-y-z velocity data and/or angular velocity data around x-y-z axes), 3D orientation data, acceleration data, environmental data, odometry data associated with vehicle states, kinematic data, dynamics data, point of interest data, and/or the like. For example and without limitation, initial route and/or trajectory information 102 may comprise one or more of longitude information, latitude information, other location information provided by a global positioning system (“GPS”), vehicle speed information, acceleration information, environmental data such as weather information, object detection information, visual information such as light detection and ranging (“LIDAR”) information, radio detection and ranging (“RADAR”) information, information generated based on interaction between the vehicle and/or associated sensors with one or more infrastructure sensors, and/or the like.

In some embodiments, initial route and/or trajectory information 102 may comprise information and/or data providing coordinates and/or orientation of a vehicle in a local frame and/or world, which in some implementations may be obtained using Normal Distributions Transform Monte Carlo Localization (“NDT-MCL”) methods from available position and/or localization data and/or data sources, although other suitable methods and/or techniques may also be used. In some embodiments, the information 102 may comprise radar localization data. In certain embodiments, the initial route and/or trajectory information 102 may comprise x, y, and/or z positional coordinate information, linear velocity information (which may be expressed in terms of x-y-z components), angular velocity information (which may be expressed around x-y-z axes), and/or the like. In further embodiments, the initial route and/or trajectory information 102 may comprise, for example and without limitation, information provided by a GPS and/or a global navigation satellite system (“GNSS”), real-time kinematic (“RTK”) positioning data, inertial measurement unit (“IMU”) acceleration and rotation data, 3D orientation data, path curvature data, acceleration data, jerk data, position covariance data and/or other metrics indicative of positioning quality, and/or the like

Initial route and/or trajectory information 102 may be generated by a variety of vehicle sensors 104 and/or systems. For example and without limitation, initial route and/or trajectory information 102 may be generated by one or more GPS systems and/or other location sensors, vehicle speed sensors (“VSSs”), accelerometers, LIDAR sensors, cameras and/or other visual sensors, RADAR sensors, gyroscopes, magnetometers, odometry sensors, and/or any other type of sensor that may be included in a vehicle. Although not specifically illustrated, in some embodiments, initial route and/or trajectory information 102 may be further generated by one or more infrastructure sensors (e.g., road crossing sensors and/or the like) that may not necessarily be included in a vehicle but may generate and share information relating to the vehicle with vehicle systems and/or separate systems associated with the vehicle. Such infrastructure sensor information may be shared with the AV 100 and/or one or more other systems (e.g., an AV operation service 106), which may be shared with and/or used by various systems and/or services configured to perform aspects of the disclosed systems and methods.

As used herein, a route may comprise a path, potentially delineated by any number of intermediate points and/or destinations. For example, a bus route may comprise a starting location, an end destination, and/or a number of intermediate bus stop points and/or destinations. In some embodiments, a route may comprise a closed repeating path. That is, rather than defining a starting location and an ending location, a route may be defined by a number of destinations along a closed path. A trajectory may comprise one or more coordinate points, vectors, and/or the like defining a path between points and/or destinations associated with a route. For example, as discussed above, a trajectory may be represented by one or more coordinate points and/or associated velocities. A route may thus be comprised of a plurality of trajectories between various associated points and/or destinations. Although in some embodiments a route may be conceptually different than a trajectory in certain contexts, for purposes of simplicity and explanation, in certain (but not necessarily all) instances herein, these terms may be used somewhat interchangeably.

Initial route and/or trajectory information 102 may be communicated to a system 106 providing various AV operation services to the vehicle 100. In some embodiments, the initial route and/or trajectory information 102 may be communicated from the AV 100 to the AV operations service 106 via one or more intermediate systems and/or services. The AV operation service 106 may provide a variety of AV related services and/or functions including, for example and without limitation, reference route and/or trajectory information optimization services as described herein. For example, as illustrated, the AV operation service 106 may implement reference route and/or trajectory information optimization processes using a reference data manager service 108 configured to receive initial reference route and/or trajectory information 102 and to optimize and/or otherwise improve the initial information using various processes disclosed herein to generate improved reference route and/or trajectory information 110. The improved reference route and/or trajectory information 110 may be communicated to the AV 100 and/or other associated systems and/or services (e.g., fleet management services (“FMS”), a remote-control center (“RCC”) service, and/or the like) for use in connection with AV operations.

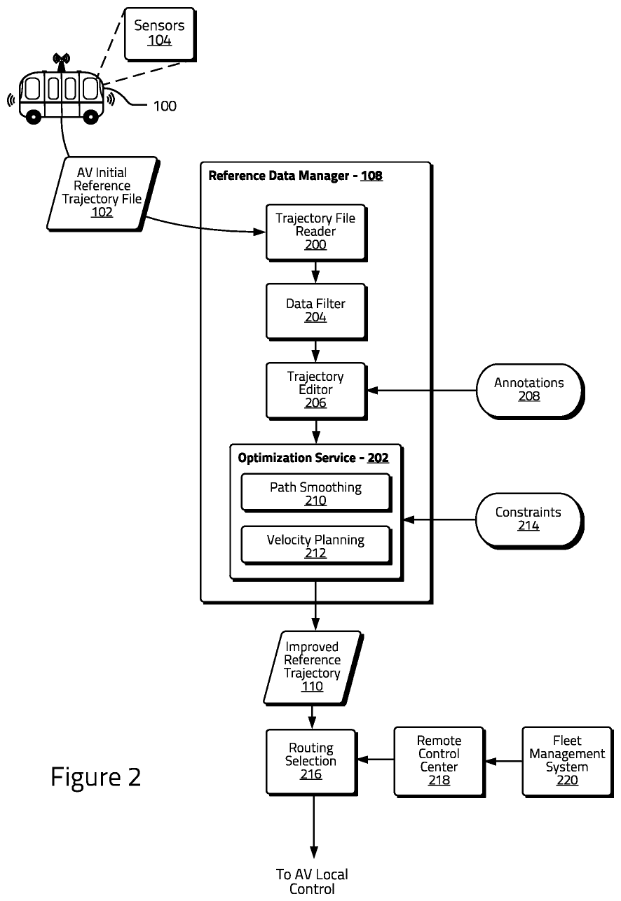

FIG. 2 illustrates a conceptual diagram showing a process of generating improved reference route and/or trajectory information 110 consistent with certain embodiments of the present disclosure. Various aspects of the illustrated process may be performed by an AV operation service system and/or associated systems and/or services (e.g., a reference data manager service 108, a global planning manager, a optimization service 202, trajectory editor service 206, and/or the like). Further aspects of the disclosed processes may be performed by one or more other associated systems including, for example and without limitation, an AV 100, AV sensor systems 104, FMSs 220, RCC services and/or systems 218, onboard and/or otherwise local AV control systems, and/or the like.

Consistent with various disclosed embodiments, initial route and/or trajectory information file (s) 102 may be provided to a trajectory file reader 200 of a reference data manager service 108. In certain embodiments, the initial route and/or trajectory information file(s) 102 may be recorded and/or otherwise be generated by one or more sensors 104 associated with AV 100, that may include any of the sensors described herein. The initial route and/or trajectory information file(s) 102 may comprise a variety of types of information, including any of the information types described herein, and/or be formatted in a variety of ways, including any of the formatting paradigms described herein.

The trajectory file reader may extract various information from the initial route and/or trajectory information file 102 and/or reformat such data for processing by the reference data manager service 108 and/or constituent services (e.g., an optimization service 202, as described in more detail below). For example, in some embodiments, the trajectory file reader 200 may extract and/or otherwise generate from the initial route and/or trajectory information file 102 spline-based data point information corresponding to associated reference route and/or trajectories, although other suitable types of data formats and/or representations of vehicle routes and/or trajectories may also be used. In certain embodiments, the initial route and/or trajectory information file 102 may comprise data in a discrete format and/or representation, which may be interpolated and/or otherwise splined to a continuous format and/or representation.

The generated and/or otherwise extracted initial reference route and/or trajectory data may be filtered using a suitable data filter 204 to improve the data before further processing. For example and without limitation, noise (e.g., sensor noise) that may be included in the generated and/or extracted initial reference route and/or trajectory data may be filtered to remove undesirable noise and/or outlier values before performing various data optimizations consistent with certain disclosed embodiments. In various embodiments, multiple types of filters may be used. In further embodiments, for location point data, coordinate values may be filtered separately (e.g., x-axis, y-axis, and z-axis coordinate data). In certain embodiments, Savitzky-Golay filtering techniques may be used, although other suitable techniques and/or types of data filtering may also be employed.

In certain embodiments, the filtered initial reference route and/or trajectory data may be provided to a trajectory editor service 206, which may be included as part of the reference data manager service 108 and/or an associated system as illustrated, and/or may be included as part of a separate system and/or service. Using the trajectory editor service 206, a user may introduce certain annotations and/or modifications 208 to the filtered initial reference route and/or trajectory data. A user may, for example and without limitation, view, modify, edit, and/or otherwise interact with the initial route and/or trajectory data using the trajectory editor service 206. In some embodiments, the trajectory editor service 206 may provide a user a visual interface with which the user may interact with route and/or trajectory data to introduce annotations and/or modifications 208. In at least one non-limiting example, a user may add one or more stops (e.g., additional bus stops) along a route and/or trajectory, change a path and/or a route (e.g., change a starting point, a destination point, and/or one or more intermediate points and/or pathways, a travel lane, etc.), and/or the like.

The reference route and/or trajectory data, potentially including annotations and/or modifications introduced via the trajectory editor service 206, may be provided to an optimization service 202. Consistent with various disclosed embodiments, the optimization service 202 may be configured to optimize and/or otherwise improve the reference route and/or trajectory data. Although various embodiments of the disclosed systems and methods may be described using the term “optimize” and/or derivatives thereof, it will be appreciated that the term may not be employed in a strict and/or otherwise limiting sense but may instead to refer to any improvement of information and/or data resulting in improved AV operation.

A variety of processes may be used by the optimization service 202 to improve and/or otherwise optimize the initial reference route and/or trajectory data (which may or may not be modified by the trajectory editor service 206). In some embodiments, vehicle-specific constraints and/or parameters 214 may be used by the optimization service 202 to improve the initial route and/or trajectory data. For example, in some embodiments, the optimization service 202 may be configured to perform longitudinal and/or lateral motion optimization to smooth and/or otherwise and/or optimize the initial route and/or trajectory information (or initial modified information if applicable) and generate improved reference route and/or trajectory information 110, taking into account vehicle-specific dynamics delineated by one or more vehicle parameters and/or constraints 214.

In some embodiments, the vehicle-specific constraints and/or parameters 214 may be provided by the reference data manager service 108, another service associated with an AV operation service and/or system, and/or a separate service and/or system. In further embodiments, the vehicle-specific constraints and/or parameters 214 may be included in the initial reference trajectory data 102 and/or otherwise communicated to the reference data manager service 108 from the AV 100, either with the initial reference trajectory file 102 and/or separately from the initial reference trajectory file 102.

In certain embodiments, the optimization service 202 may comprise a path smoothing engine 210. The path smoothing engine 210 may be configured to fit the initial reference route and/or trajectory data to one or more curves that may be kinematically and/or otherwise physically feasible to traverse by an AV associated with vehicle-specific constraints and/or parameters 214 provisioned to the optimization service 202. The fitted curve(s) may then be used as smoothed and/or otherwise improved reference route and/or trajectory data 110 for use in connection with AV operations and/or other optimization processes (e.g., velocity planning).

For example, a larger 50-person bus may be less agile and/or have a larger turning radius than a smaller passenger vehicle. Therefore, a kinematically feasible and/or physically traversable path for the bus may be different than that for the smaller vehicle (e.g., the smaller vehicle may be able to transit curved paths with tighter radii). The path smoothing engine 210 may use specific constraints and/or parameters associated with the bus and/or the passenger vehicle to, at least in part, generate improved vehicle specific route and/or trajectory data 110 that is traversable by the associated vehicle. In this manner, in the above example, improved route and/or trajectory data 110 for the bus may have larger radii curves than that for the smaller passenger vehicle.

A variety of vehicle constraints and/or parameters 214 may be used in connection with various aspects of the disclosed embodiments, including, for example and without limitation, non-holonomic and/or kinematic constraints, vehicle maximum and/or minimum turning radii, vehicle acceleration parameters, vehicle deceleration parameters (e.g., braking constraints), vehicle velocity parameters, vehicle geometry parameters (e.g., distance(s) between a vehicle's front and rear vehicle axle and/or axles, distance(s) between vehicle left and right wheels, vehicle body size, width, length, and/or height, etc.), vehicle suspension parameters, vehicle mass, vehicle tire size and/or type, vehicle tire tread and/or information relating to a coefficient of friction relative to a vehicle and a road surface under certain conditions (e.g., weather conditions) and/or the like.

In further embodiments, the optimization service 202 may comprise a velocity planning engine 212. Although illustrated and/or described herein as a velocity planning engine 212, it will be appreciated that the engine 212 may not necessarily be limited to only velocity planning in connection with generating improved route and/or trajectory data 110, but may also be used in connection with acceleration and/or deceleration planning operations. The velocity planning engine 212 may process initial reference route and/or trajectory data (which may be potentially smoothed based on vehicle specific parameters and/or constraints 214 by the path smoothing engine 210) to optimize and/or otherwise improve the velocity, acceleration, and/or deceleration of the vehicle over the route and/or trajectory while accounting for various variables such as, for example and without limitation, route and/or trajectory curvature, vehicle operator specific constraints, and/or passenger comfort. In various embodiments, the velocity planning engine 212 may employ one or more vehicle specific parameters 214 and/or constraints in connection with vehicle velocity, acceleration, and/or deceleration planning along the route.

For example, a vehicle with a lower passenger riding position and stiffer suspension may traverse a particular curved trajectory at a higher velocity than a vehicle with a higher passenger riding position and softer suspension without detrimentally impacting passenger comfort. In another example, a vehicle with a passenger riding position behind a rear wheel axle by a certain distance may need to traverse a particular curved trajectory at a slower velocity than a vehicle with a passenger riding position between the vehicle axles to maintain passenger comfort. Using velocity planning optimization consistent with various aspects of the disclosed embodiments may thus help to ensure that passenger comfort is maintained along a trajectory for a specific vehicle.

Improved reference route and/or trajectory information 110 generated by the optimization service 202 of the reference data manager service 108 may be provided to an AV routing selection service 216, which may be implemented by the same system and/or service implementing the reference data manager service 108 and/or another system and/or service configured to control and/or otherwise manage the operations of one or more AVs. In some embodiments, the routing selection service 216 may be associated with and/or otherwise communicate with an RCC service 218 and/or a FMS 220, and may be used to provide certain AV operational control decisions. The routing selection service 216 may, for example and without limitation, be used by the remote-control center 218 and/or the FMS 220 to select and/or transmit a particular route and/or trajectory to an AV for execution by one or more associated motion control systems. When a particular route and/or trajectory is selected, the associated improved reference trajectory 110 information may be communicated to various local control systems of a subject AV.

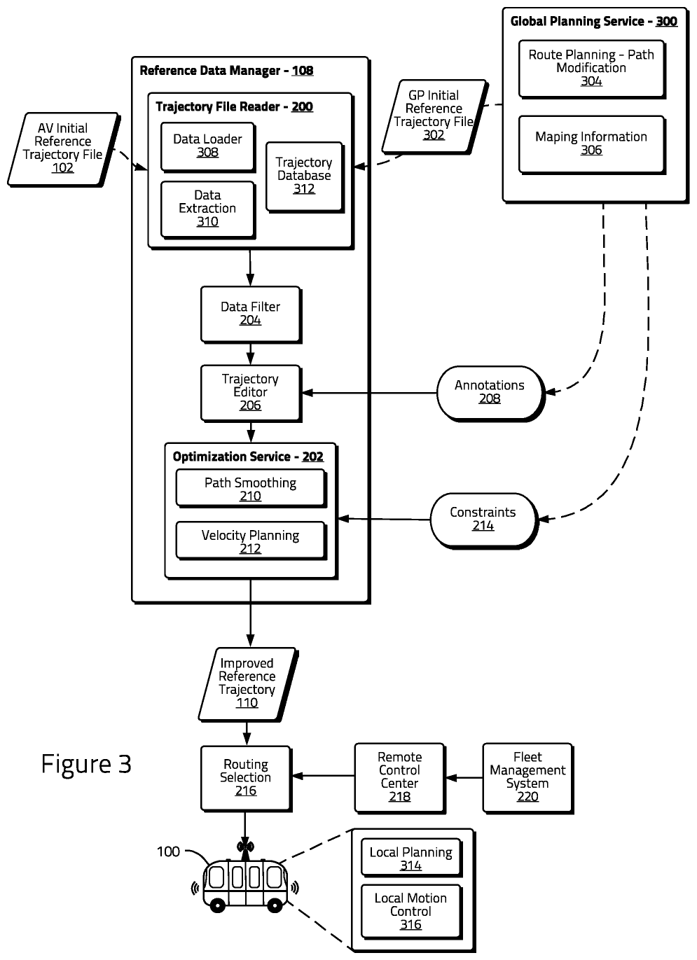

FIG. 3 illustrates a conceptual diagram showing a process of generating improved reference route and/or trajectory information including offline planning and/or path modification services consistent with certain embodiments of the present disclosure. Various aspects of the illustrated process may be performed by an AV operation service system and/or associated systems and/or services (e.g., a reference data manager service 108, a global planning service 300, an optimization service 202, and/or the like). Further aspects of the disclosed processes may be performed by one or more other associated systems including, for example and without limitation, an AV, AV sensor systems, FMSs 220, RCC services and/or systems 218, onboard and/or otherwise local AV control systems 314, 316, and/or the like.

In certain embodiments, a global planning service 300 may be used to generate one or more initial reference routes and/or trajectories that may, at least in part, not necessarily be based on reference route and/or trajectory information obtained by a AV and/or associated sensors. For example, a user may interact with a global planning service 300 to generate and/or otherwise lay out reference route and/or trajectory information that may be used as initial reference route and/or trajectory data by the reference data manager service 108. This may allow, among other things, for the flexible creation and/or modification of routes and/or trajectories by a user of the global planning service 300 without necessarily having to transit the route with a test and/or reference AV to capture the associated reference route and/or trajectory data.

For example and without limitation, as shown, route planning and/or path modification services 304 executing on the global planning service 300 may allow a user to interact with one or more maps and/or other information representative of a potential route (e.g., mapping information 306) and to define one or more initial reference routes and/or trajectories. In some embodiments, a reference route and/or trajectory may be created by a user by defining one or more starting points, ending points, and/or any number of intermediate points, and trajectories may be automatically defined along permitted pathways (e.g., roadways and/or the like) between such points using any suitable technique and/or combination of techniques. In further embodiments, a reference route and/or trajectory defined by a user may comprise various points along a route and/or a defined trajectory between such points. Initial reference route and/or trajectory file information 302 generated by the global planning service 300 may be provided to the trajectory file reader 200 of the reference data manager service 108.

As illustrated, the global planning service 300 may further be configured to interface with the reference data manager 108 to provide one or more route and/or trajectory annotations and/or modifications to the trajectory editor service 206. For example, in some embodiments, the global planning service 300 may be configured provide annotations and/or modifications to routes and/or trajectories associated with initial reference routes and/or trajectories defined by the global planning service 300 (e.g., initial reference route and/or trajectory file 302) and/or generated by an AV driving the reference route (e.g., initial reference route and/or trajectory file 102).

For example, in some embodiments, the global planning service 300 may be used to interface with the trajectory editor 206 to allow a user to view, modify, edit, and/or otherwise interact with initial route and/or trajectory information associated with initial reference route and/or trajectory files 102, 302. For example and without limitation, a user may add one or more stops (e.g., additional bus stops) along a route and/or trajectory, modify, replace, and/or otherwise a trajectory and/or path and/or a route and/or a segment thereof (e.g., changing a starting point, an intermediate destination point, and/or one or more intermediate points and/or pathways, etc.), change traffic rules that may influence routing and vehicle position along a particular path, and/or the like. Although illustrated as separate services, it will be appreciated that various functions of the global planning service 300, the trajectory editor service 206, then reference data manager service 108, and/or an associated AV operation service system 106 may be integrated into a single service and/or system and/or any suitable combination of services and/or systems.

A trajectory file reader 200 of the reference data manager service 108 may be used to extract various information from initial route and/or trajectory information files 102, 302 generated by an AV and/or the global planning service 300. For example, in some embodiments, a data loader 308 may be used to load and/or ingest the reference trajectory files 102, 302, and a data extraction engine 310 may be configured to extract corresponding route and/or trajectory data. As described above, in various embodiments, the initial route and/or trajectory information file 102, 302 may comprise point data, which may be extracted and formatted as spline-based data point information. Extracted route and/or trajectory information data may be stored in a trajectory database 312 maintained by the reference data manager service 108 (e.g., maintained locally and/or remotely).

The extracted initial reference route and/or trajectory data may be filtered by a data filter 204 to remove certain noise and then passed to a trajectory editor service 206 for possible modification as described herein. The trajectory editor service 206 modify and/or edit the filtered initial reference route and/or trajectory data in accordance with any applicable annotations and/or modifications 208, which may be received by the reference data manager service 108 and/or the trajectory editor service 206 directly from a user interacting with the trajectory editor service 206 and/or through provisioning from the global planning service 300.

The reference route and/or trajectory data, potentially including annotations and/or modifications introduced via the trajectory editor service 206 and/or the global planning service 300, may be provided to an optimization service 202. Consistent with various disclosed embodiments, the optimization service 202 may be configured to optimize and/or otherwise improve the reference route and/or trajectory data. A variety of processes may be used by the optimization service 202 to improve and/or otherwise optimize the initial reference route and/or trajectory data (which may or may not be modified by the trajectory editor service 206 and/or the global planning service 300).

As discussed above, in some embodiments, vehicle-specific constraints and/or parameters 214 may be used by the optimization service 202 to improve the initial route and/or trajectory data. For example, in certain embodiments, the optimization service 202 may be configured to perform longitudinal and/or lateral motion optimization to smooth and/or otherwise and/or optimize the initial route and/or trajectory information (or initial modified information if applicable) and generate improved reference route and/or trajectory information 110 using the path smoothing engine 210 and/or the velocity planning engine 212, taking into account vehicle-specific dynamics delineated by one or more vehicle parameters and/or constraints 214. Using an optimization process consistent with embodiments disclosed herein, the optimization service 202 may generate improved reference route and/or trajectory data that may be kinematically feasible for traversal by a particular AV and/or may provide improved passenger comfort while traversing the route.

In some embodiments, the optimization service 202 may optimize recorded route and/or trajectory information offline. In certain embodiments, quadratic-programming (“QP”) problem solving optimization techniques may be employed. By constraining the limitations of the vehicle dynamics (that may be configurable for different vehicle parameters), a feasible route and/or trajectory allowing comfortable autonomous navigation may be determined. Moreover, as noted above, in various embodiments, velocity planning techniques may further be employed that consider dynamic, kinematic, road curvature, and/or motion constraints, that may improve passenger comfort as a vehicle traverses the route and/or trajectory.

Consistent with embodiments disclosed herein, integration of a global planning manager 300 may allow route and/or trajectory information to be modified if needed during vehicle deployment without necessarily requiring recapturing reference route and/or trajectory information by an AV. For example, a bus stop may be added to a trajectory, path modifications may be introduced (e.g., due to road construction and/or the like), speed modifications may be made due to changes in traffic rules, and/or the like. It will be appreciated that a variety of algorithms, techniques, and/or strategies may be used in connection with global planning processes 300 and/or route and/or trajectory modification, and that any suitable algorithms, techniques, and/or strategies may be employed in connection with the disclosed embodiments.

Improved reference trajectory and/or route information 110 may be output from the reference data manager 108 and be used to improve the deployment and/or autonomous operation of AVs. For example and without limitation, in some embodiments, the improved reference trajectory and/or route information 110 may allow for better following of physical road lanes, provide improved AV vehicle behavior and/or driving dynamics, and/or may streamline the deployment process of AVs.

In some embodiments, the improved reference route and/or trajectory information 110 may be formatted as an optimal initial global trajectory vector that may be used by AVs and/or associated systems in connection with AV operation. The trajectory vector may comprise information associated with the reference trajectory that a vehicle may publish to high-level trajectory tracking control, potentially after processing by a local planning block checking for potential collisions. In various embodiments, the information may comprise, for example and without limitation, desired vehicle states, coordinate information, vehicle speed information, acceleration information, heading information (e.g., 3D orientation information, yaw information, etc.), point of interest information, and/or any other suitable data that may be added and/or otherwise configured depending on a particular application.

For example, as illustrated, the improved reference route and/or trajectory information 110 generated by the optimization service 202 of the reference data manager service 108 may be provided to an AV routing selection service 216, which may be implemented by the same system and/or service implementing the reference data manager service 108 and/or another system and/or service configured to control and/or otherwise manage the operations of one or more AVs. In some embodiments, the routing selection service 216 may be associated with and/or otherwise communicate with an RCC service 218 and/or an FMS 220, and may be used to provide certain AV operational control decisions. The routing selection service 216 may, for example and without limitation, be used by the remote-control center 218 and/or the FMS 220 to select and/or transmit a particular route and/or trajectory to an AV 100 for execution by one or more associated motion control systems.

When a particular route and/or trajectory is selected, the associated improved reference trajectory 110 information may be communicated to various local control systems 314, 316 of a subject AV 100. Local route planning systems 314 and/or local motion control systems 316 associated with the AV 100 may then traverse the route and/or trajectories associated with the improved reference route and/or trajectory information 110.

It will be appreciated that several variations can be made to the architecture, relationships, and examples presented in connection with FIGS. 1-3 within the scope of the inventive body of work. For example, certain illustrated processing steps and/or functionalities may be performed by a single system and/or service and/or be distributed between multiple systems and/or services. Moreover, certain information processing workflows may be modified to include additional processing steps, eliminate certain processing steps, and/or reorder certain processing steps. Thus, it will be appreciated that the architecture, relationships, and examples presented in connection with FIGS. 1-3 are provided for purposes of illustration and explanation, and not limitation.

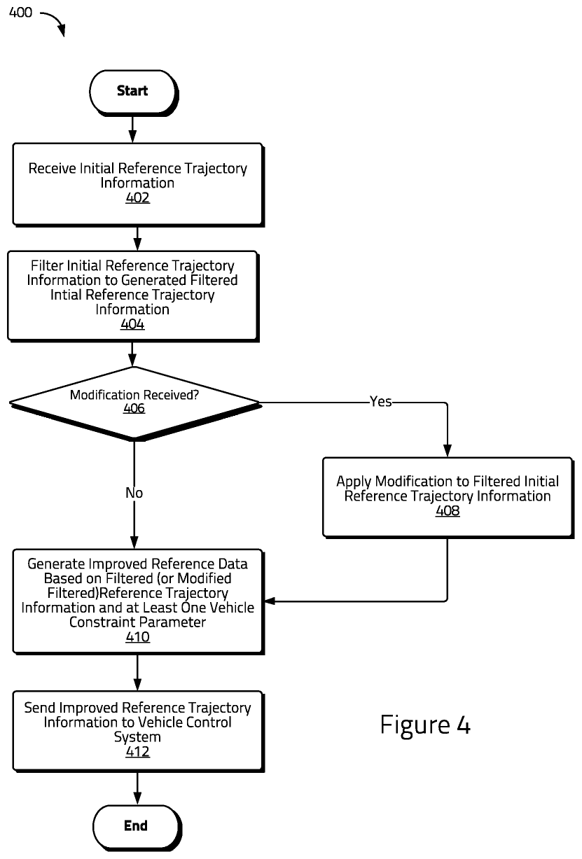

FIG. 4 illustrates a flow chart of an example of a method 400 of generating improved reference route and/or trajectory information consistent with certain embodiments of the present disclosure. The illustrated method 400 may be implemented in a variety of ways, including using software, firmware, hardware, and/or any combination thereof. In certain embodiments, various aspects of the method 400 and/or its constituent steps may be performed by an AV operations service, a reference data manager service, a trajectory editor service, an optimization service, a global planning service, associated systems, and/or any other service and/or system and/or combinations of services and/or systems that may be used to implement various aspects of the disclosed systems and methods.

At 402, initial reference trajectory information may be received by a data reference manager service. In some embodiments, the initial reference trajectory data may be associated with an initial vehicle reference route. Initial reference trajectory data may be received from, for example and without limitation, a reference vehicle and/or an associated system, and may comprise data generated by at least one sensor system of a reference vehicle while transiting the reference route. In further embodiments, the initial reference trajectory data may be received from a global planning service system.

The initial reference trajectory data may comprise a variety of types of data structured in a variety of different ways. In some embodiments, the initial reference trajectory data may comprise location point data associated with the initial vehicle reference route. In some embodiments, the initial reference trajectory data may comprise velocity data. It will be appreciated that the reference trajectory data may comprise a variety of types of information generated by a variety of types of sensors and/or systems, and may include any of the types of initial reference trajectory data and/or information described herein.

The initial reference trajectory data may be filtered at 404 to generate filtered initial reference trajectory data. A variety of filtering techniques may be employed. In some embodiments, filtering may remove noises and/or certain outlier data from the initial reference trajectory data (e.g., sensor noise and/or the like).

At 406, it may be determined whether one or more modifications to the reference trajectory data have been received by the reference data manager service and/or an associated trajectory editor service. For example, in some embodiments, the modification may be received from a user interacting with a trajectory editor service, which in some implementations may be associated with the reference data manager service. In further embodiments, the modification may be received from a global planning service system.

If one or more modifications to the reference trajectory data have been received, the data manager service and/or an associated trajectory editor service may apply the modifications to the filtered initial reference trajectory data to generate modified reference trajectory data at 408. In some embodiments, the modification may comprise modifying at least one trajectory segment associated with the filtered initial reference trajectory data (e.g., modifying at least a part of an associated path). In further embodiments, the modification may comprise modifying at least one intermediate destination associated with the filtered referenced trajectory data and/or an associated route (e.g., adding, removing, and/or changing an intermediate destination) and/or starting and/or end points of a route.

At 410, improved reference trajectory data may be generated based on the filtered or the modified filtered reference trajectory data and at least one vehicle constraint parameter. Vehicle constraint parameters may comprise, for example and without limitation, one or more of a distance between at least one front and a least one rear vehicle axle, a distance between a vehicle left tire and right tire, vehicle mass, vehicle tire size, vehicle tire tread information, vehicle length, vehicle width, other vehicle constraint parameters described herein, and/or any other suitable parameter(s). In some embodiments, generating improved reference trajectory data may comprise a data improvement and/or optimization process consistent with aspects of the disclosed embodiments that result in improved reference trajectory data associated with a route that may be kinematically feasible for traversal by a particular vehicle and/or may provide improved passenger comfort while traversing the route.

The reference data manager service may send the improved reference trajectory data to a control system associated with a vehicle. One or more vehicle control systems (e.g., local planning and/or local controls systems) may then use the improved reference trajectory data in connection with controlling the vehicle while traversing a reference route associated with the improved reference trajectory data.

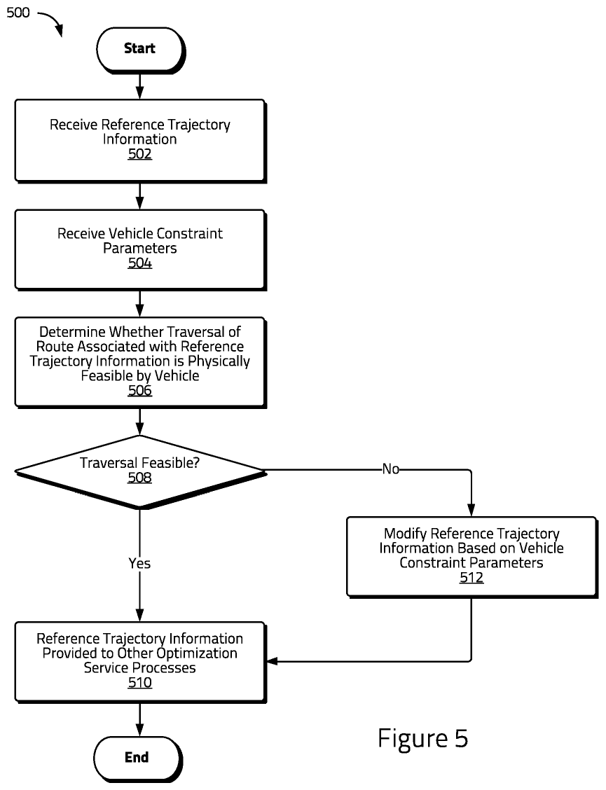

FIG. 5 illustrates a flow chart of an example of a method 500 of improving reference route and/or trajectory information based on vehicle parameters consistent with certain embodiments of the present disclosure. In some embodiments, the illustrated method 500 may facilitate a path smoothing process consistent with various aspects of the disclosed embodiments. The illustrated method 500 may be implemented in a variety of ways, including using software, firmware, hardware, and/or any combination thereof. In certain embodiments, various aspects of the method 500 and/or its constituent steps may be performed by an AV operations service, a reference data manager service, an optimization service, a path smoothing engine, and/or any other service and/or system and/or combinations of services and/or systems that may be used to implement various aspects of the disclosed systems and methods.

At 502, reference trajectory data may be received. In some embodiments, the reference trajectory data may comprise initial reference trajectory data that may or may not have been filtered and/or modified and/or otherwise annotated (e.g. modified by a trajectory editor service and/or a global planning service). Vehicle constraint parameters may be received at 504. In some embodiments, the vehicle-specific constraints and/or parameters may be provided by a reference data manager service, another service associated with a vehicle operation service and/or system, and/or a separate service and/or system. In further embodiments, the vehicle-specific constraints and/or parameters may be included in the initial reference trajectory data and/or otherwise received from the vehicle, either with or separate from the reference trajectory data.

At 506, it may be determined whether a vehicle associated with at least one of the vehicle constraint parameters is physically able to traverse a route defined by the vehicle reference trajectory data. If traversal of the route is kinematically and/or otherwise physically feasible by the route, the reference trajectory data may be passed to other optimization processes at 510 without modification. If, however, traversal of the route by a subject vehicle is not feasible, the reference trajectory data may be modified at 512 to fit one or more kinematically and/or otherwise traversable curves and/or paths for the vehicle, thereby generating traversable reference trajectory data. The traversable reference trajectory data may then be passed to other optimization processes at 510, reflecting the modifications to the data so that it is associated with a kinematically and/or otherwise traversable feasible path.

In various disclosed embodiments, path smoothing consistent with embodiments disclosed herein may allow for improvement of certain non-time dependent variables (e.g., x, y, z, position, heading angle, steering angle, etc.) associated with a route and/or path associated with trajectory data. As described above, path smoothing may generate a kinematically and/or physically traversable reference trajectory based on non-holonomic and/or other vehicle specific constraints and/or parameters, potentially with fewer sudden and/or abrupt turns, jumps, oscillations, and/or the like than reference data captured by an AV with a human driver.

Path smoothing may, in some embodiments, operate to ensure that transitions between consecutive points defining a trajectory are relatively smooth and/or continuous and allow for traversal of the trajectory by a vehicle in accordance with kinematic and/or non-holonomic parameters and/or constraints associated with the vehicle. In certain embodiments, the parameters and/or constraints may be used to define a model of the associated vehicle used to determine whether the vehicle can physically traverse the trajectory. In various embodiments, spline-based methods (e.g., polinoms) may be used in connection with path smoothing. In further embodiments, points along the smoothed path may be resampled so that smoothed reference trajectory data comprises regularly spaced location point data.

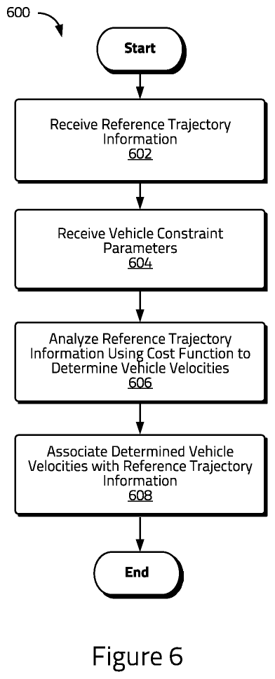

FIG. 6 illustrates a flow chart of an example of a method 600 of improving reference route and/or trajectory information using velocity planning techniques consistent with certain embodiments of the present disclosure. The illustrated method 600 may be implemented in a variety of ways, including using software, firmware, hardware, and/or any combination thereof. In certain embodiments, various aspects of the method 600 and/or its constituent steps may be performed by an AV operations service, a reference data manager service, an optimization service, a velocity planning engine, and/or any other service and/or system and/or combinations of services and/or systems that may be used to implement various aspects of the disclosed systems and methods.

At 602, reference trajectory information may be received. In some embodiments, the reference trajectory data may comprise initial reference trajectory data that may or may not have been filtered and/or modified and/or otherwise annotated (e.g. modified by a trajectory editor service and/or a global planning service). In further embodiments, the reference trajectory data may comprise reference trajectory data that has undergone and/or otherwise been improved using path smoothing optimization techniques as described herein.

Vehicle constraint parameters may be received at 604. In some embodiments, the vehicle-specific constraints and/or parameters may be provided by a reference data manager service, another service associated with a vehicle operation service and/or system, and/or a separate service and/or system (e.g., a vehicle operating service system). In further embodiments, the vehicle-specific constraints and/or parameters may be included in the initial reference trajectory data and/or otherwise received from the vehicle, either with or separate from the reference trajectory data. Although described as vehicle constraint parameters, in some embodiments, the constraint parameters received at 604 may not be specific to a particular vehicle, but may more generally relate to passenger comfort parameters. For example, passenger comfort may be reduced if they experience acceleration and deceleration forces beyond certain thresholds, which may be independent of the particular vehicle in which they are riding in.

A variety of vehicle constraint parameters may be used in connection with velocity planning operations consistent with aspects of the disclosed embodiments, including any of the vehicle constraint parameters described herein. In some embodiments, vehicle constraint parameters used in velocity planning may comprise, for example and without limitation, maximum vehicle velocity, vehicle longitudinal and/or lateral acceleration and/or deceleration, jerk, and/or the like.

At 606, the reference trajectory data may be analyzed against a cost function to determine one or more vehicle velocities along a path associated with the reference trajectory data. In some embodiments, the vehicle constraint parameters may be weighted in the cost function analysis to balance passenger comfort considerations. For example, increased longitudinal acceleration may be less impactful to passenger comfort than lateral acceleration, so reducing lateral acceleration while transiting the path defined by the reference trajectory data may be weighted with increased importance in the analysis. In some embodiments, certain components in a cost function may be used as soft constraints rather than hard constraints. For example and without limitation, instead of a firm constraint where velocity must be less than a certain value, a cost function may operate to maintain lateral and longitudinal acceleration at some specified level, giving weights to these variables (which may be different weights) when solving the optimization.

Based on the analysis, one or more vehicle velocities along the path associated with the reference trajectory data may be assigned and/or otherwise changed from the original trajectory data provided to the velocity planning processes (e.g., increased and/or decreased). For example, location point data included in the reference trajectory data may be associated with one or more vehicle velocities and/or certain vehicle velocities previously associated with the location point data may be changed. In various embodiments, velocities may be assigned and/or changed along an entire path and/or along one or more sections of the path depending on the results of the analysis. In this manner, velocity planning optimization consistent with various aspects of the disclosed embodiments may operate to ensure that passenger comfort is maintained along a trajectory for a specific vehicle. Reference trajectory data including associated velocities assigned by velocity planning may be passed to other optimization processes and/or systems for provisioning to a vehicle at 608.

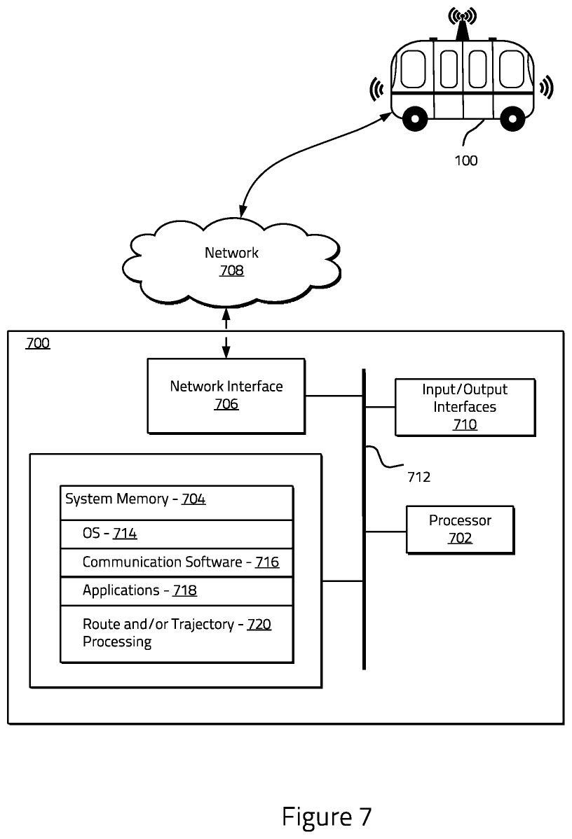

FIG. 7 illustrates an example of a system 700 that may be used to implement certain embodiments of the systems and methods of the present disclosure. Certain elements associated with the illustrated system 700 may be included in a system associated with an AV operations and/or deployment service and/or any other system and/or service configured to implement aspects of the embodiments of the systems and methods disclosed herein.

As illustrated in FIG. 7, the system 700 may include: a processing unit 702; system memory 704, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 702; a port for interfacing with one removable memory that may include one or more diskettes, optical storage mediums, and/or other non-transitory computer-readable storage mediums (e.g., flash memory, thumb drives, USB dongles, compact discs, DVDs, etc.); a network interface 706 for communicating with other systems (including systems associated with an AV 100) via one or more network connections 708 using one or more communication technologies and/or channels; a user interface 710 that may include a display and/or one or more input/output devices such as, for example, a touchscreen, a keyboard, a mouse, a track pad, and the like; and one or more busses 712 for communicatively coupling the elements of the system.

The operation of the system 700 may be generally controlled by the processing unit 702 by executing software instructions and programs stored in the system memory and/or internal memory of the processing unit. The system memory 704 may store a variety of executable programs or modules for controlling the operation of the system 700. For example, the system memory 704 may include an operating system (“OS”) 714 that may manage and coordinate, at least in part, system hardware resources and provide for common services for execution of various applications, modules, and/or services.

The system memory 704 may further comprise, for example and without limitation, communication software 716 configured to enable in part communication with and by the system 700; one or more applications 718; reference route and/or trajectory processing modules 720 and/or services configured to perform various functions of a reference data manager service, aspects thereof, and/or related functions and/or operations consistent with various aspects of the disclosed embodiments; and/or any other information and/or applications configured to implement embodiments of the systems and methods disclosed herein.

The systems and methods disclosed herein are not limited to any specific computer, device, service, or other apparatus architecture and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein but may be modified with the scope and equivalents of the appended claims.

What is claimed is:

1. A method for generating reference trajectory data for a vehicle performed by a vehicle operations control system implementing a reference data manager service, the vehicle operations control system comprising a processor and a computer-readable storage medium storing instructions that, when executed by the processor, cause the vehicle operations control system to perform the method, the method comprising:
receiving initial reference trajectory data associated with an initial vehicle reference route;
filtering the initial reference trajectory data to generate filtered initial reference trajectory data;
generating improved reference trajectory data based on the filtered initial reference trajectory data and at least one vehicle constraint parameter; and
sending, to a control system associated with a vehicle, the improved reference trajectory data for use in controlling the vehicle along an improved vehicle reference route associated with the improved reference trajectory data.

2. The method of claim 1, wherein the initial reference trajectory data comprises data generated by at least one sensor system of a reference vehicle.

3. The method of claim 1, wherein the initial reference trajectory data is received from a global planning service system.

4. The method of claim 1, wherein filtering the initial reference trajectory data comprises removing sensor noise from the initial reference trajectory data.

5. The method of claim 1, wherein the method further comprises prior to generating the improved reference trajectory data, determining that a modification to the filtered initial reference trajectory data has been received by the reference data management service.

6. The method of claim 5, wherein the method further comprises:
applying the modification to the filtered initial reference trajectory data to generate modified initial reference trajectory data;
wherein generating the improved reference trajectory data is based on the modified initial reference trajectory data.

7. The method of claim 6, wherein the modification comprises modifying at least one trajectory segment associated with the filtered initial reference trajectory data.

8. The method of claim 6, wherein the modification comprises modifying at least one intermediate destination associated with the filtered initial reference trajectory data.

9. The method of claim 8, wherein modifying the at least one intermediate destination comprises adding at least one intermediate destination associated with the filtered initial reference trajectory data.

10. The method of claim 5, wherein the modification is received from a user interacting with a trajectory editor service associated with the reference data management service.

11. The method of claim 5, wherein the modification is received from a global planning service system.

12. The method of claim 1, wherein the vehicle comprises at least one of an autonomous vehicle, a semi-autonomous vehicle, and an assisted driving vehicle.

13. The method of claim 1, wherein the vehicle comprises at least one of a passenger vehicle, a transit service vehicle, a freight vehicle, a land vehicle, a watercraft, and an aircraft.

14. The method of claim 1, wherein the initial reference trajectory data comprises location point data associated with the initial vehicle reference route.

15. The method of claim 1, wherein the initial reference trajectory data comprises velocity data.

16. The method of claim 1, wherein generating improved reference trajectory data comprises determining whether a vehicle associated with the at least one vehicle constraint parameter is physically able to traverse the initial vehicle reference route based on the at least one vehicle constraint parameter.

17. The method of claim 16, wherein the at least one vehicle constraint parameter comprises at least one of a distance between at least one front and a least one rear vehicle axle, a distance between a vehicle left and right tires, vehicle mass, vehicle tire size, vehicle tire tread information, vehicle length, and vehicle width.

18. The method of claim 16, wherein determining whether a vehicle associated with the at least on vehicle constraint parameter is physically able to traverse the initial vehicle reference route comprises determining that the vehicle associated with the at least one vehicle constraint parameter is physically unable to traverse the initial vehicle reference route based on the at least one vehicle constraint parameter, and the method further comprises:
modifying the filtered initial reference trajectory data based on the at least one vehicle constraint parameter to generate vehicle traversable reference trajectory data, the vehicle traversable reference trajectory data being associated with a traversable route by the vehicle associated with the at least one vehicle constraint parameter; and
wherein generating the improved reference trajectory data is based on the vehicle traversable reference trajectory data.

19. The method of claim 1, wherein generating improved reference trajectory data comprises determining a velocity associated with one or more points associated with the improved reference trajectory data based on the at least one vehicle constraint parameter.

20. The method of claim 19, wherein the at least one vehicle constraint parameter comprises at least one allowable passenger acceleration constraint parameter.
